(19) United States
(12) Patent Application Publication
(10) Pub. No.: US 2021/0293694 A1
(43) Pub. Date: Sep. 23, 2021

(54) Hydrogen Analysis System

(71) Applicant: Nippon Telegraph and Telephone Corporation, Tokyo (JP)

(72) Inventors: Yosuke Takeuchi, Musashino-shi, Tokyo (JP); Azusa Ishii, Musashino-shi, Tokyo (JP); Takuya Kamisho, Musashino-shi, Tokyo (JP); Soichi Oka, Musashino-shi, Tokyo (JP)

(21) Appl. No.: 17/258,381

(22) PCT Filed: Jun. 28, 2019
(86) PCT No.: PCT/JP2019/025923

§ 371 Date: Jan. 6, 2021

(30) Foreign Application Priority Data
Jul. 17, 2018 (JP) 2018-134078

(51) Int. Cl. G01N 17/02; G01N 27/28; G01N 27/416; G01N 1/32

(52) U.S. Cl. CPC G01N 17/02; G01N 1/32; G01N 27/416; G01N 27/28

(57) ABSTRACT

A test time for measuring hydrogen diffusion in a steel material is improved. The reproducibility of a position where hydrogen exists in the steel material is improved. A control terminal controls a solution supply/discharge control device, a gas supply control device, a first potentiostat/galvanostat, and a second potentiostat/galvanostat on the basis of a predefined procedure, so that a plurality of processing steps, which are performed for analyzing hydrogen diffused from the inside to the surface of a steel material to be measured, are performed continuously. Further, the processing of inactivating the surface of the steel material to be measured is performed before the main processing using a metal ion replacement method, or an inert gas is injected into the solution during the main processing.

### TECHNICAL FIELD

The present invention relates to a technique for analyzing hydrogen diffused from the inside to the surface of a steel material.

### BACKGROUND ART

In recent years, the demand for a high-strength steel material is increasing. Meanwhile, it is known that the higher the strength of a steel material, the higher the susceptibility to hydrogen embrittlement. The hydrogen embrittlement is a dangerous fracture mode since it causes sudden fracture without showing large plastic deformation, and the hydrogen embrittlement occurs when stress is applied in an environment where hydrogen exists in a high-strength steel material.

Since the hydrogen embrittlement is caused by the existence of hydrogen as thus described, it is important to understand, by measuring the entry of hydrogen into a steel material (metal, etc.) and hydrogen diffusion in the metal, the possibility for the occurrence of the hydrogen embrittlement in an environment where the metal is disposed, as well as the material properties of the metal.

As a method for measuring hydrogen diffusion in metal, for example, the Devanathan method has been used (Non-Patent Literature 1). The Devanathan method is a method of generating hydrogen on one surface (rear surface) of the metal and detecting hydrogen diffused in the metal on the other surface (front surface). In addition, a method has been proposed where the Devanathan method is applied and metal is placed in a corrosive environment that generates hydrogen to measure the amount of hydrogen having entered the metal in a natural environment (Patent Literature 1).

The method for measuring hydrogen diffusion in metal also includes a hydrogen permeation method. In the hydrogen permeation method, the amount of hydrogen dissolved and a hydrogen diffusion constant are derived by applying a time lag method or the like to a hydrogen permeation curve obtained by measurement. However, this method is limited to characteristic evaluation for a bulk and cannot evaluate at which position in the metal hydrogen is likely to exist and which position is likely to be the starting point of the hydrogen embrittlement.

Therefore, as a method for evaluating the position where hydrogen exists as thus described, a metal ion replacement method has been used in which the position of hydrogen is visualized by replacing hydrogen diffused from the inside to the surface of the metal with replacing-metal ions. As an example of the metal ion replacement method, a silver decoration method is known (Non-Patent Literature 2), and in the silver decoration method, metal which contains diffusible hydrogen is immersed in a replacing-metal ion solution, and hydrogen diffused from the inside the metal to the surface of thereof is replaced with replacing-metal ions in the replacing-metal ion solution. The replacing-metal ions are deposited as replacing-metal particles at the position where hydrogen exists and remain even after the replacing-metal ion solution is removed, and hence the position where hydrogen exists in the metal can be estimated by observing the position where the replacing-metal particles have been deposited after cleaning of the metal.

### CITATION LIST

### Patent Literature

Patent Literature 1: Japanese Patent Laid-Open No. 2013-044728

### Non-Patent Literature

Non-Patent Literature 1: “The adsorption and diffusion of electrolytic hydrogen in palladium”, written by M. A. V. Devanathan and one other, Proc. Roy. Soc. London, Ser. A, 270, 1962, p. 90-p. 102
Non-Patent Literature 2: “Hydrogen Visualization in Steels Using Ag Decoration Method”, written by Akiyama and one other, Journal of the Japan Institute of Metals and Materials, vol. 77, 2013, p. 622-p. 626

### Summary of the Invention

### Technical Problem

However, the conventional methods described above have a problem of requiring a long test time. In addition, the conventional metal ion replacement method has a problem of being low in reproducibility of the position where hydrogen exists. The reasons for these are considered as follows: (1) pre-processing such as degreasing of a metal sample, main processing using the metal ion replacement method, and post-processing such as neutralization are performed individually and the processing is complicated; (2) after mechanical polishing of a metal sample, when the processing of removing the surface layer of the metal sample by electrolytic polishing or chemical polishing is performed for the purpose of removing abrasive grains and surface hardened layers, it is difficult to conduct tests under the same conditions because the polishing solution deteriorates rapidly; and (3) in the replacement with replacing-metal ions, a change in the pH of the replacing-metal ion solution may cause the replacing-metal ions to precipitate as a compound, which is mixed with a replacing-metal that has replaced hydrogen diffused in the metal and has been disposed on the metal surface.

The present invention has been made in view of the above circumstances, and a first object of the present invention is to improve a test time for measuring hydrogen diffusion in a steel material, and a second object is to improve the reproducibility of a position where hydrogen exists in the steel material.

### Means for Solving the Problem

A hydrogen analysis system according to the present invention includes: two cells that hold a steel material to be measured with side solution release windows; a solution supply/discharge control mechanism that injects and discharges a solution into and from each of the two cells, and controls supply/discharge of the solution to be injected into and discharged from each of the two cells; a gas supply control mechanism that injects a gas into a cell on a hydrogen detection side of the two cells and controls supply of the gas to be injected into the cell on the hydrogen detection side; and a control terminal that controls the solution supply/discharge control mechanism and the gas supply control mechanism. The control terminal controls the solution supply/discharge control mechanism and the gas supply control mechanism on the basis of a predefined procedure to continuously perform a plurality of processing steps that are performed for analyzing hydrogen diffused from an inside to a surface of the steel material to be measured.

The hydrogen analysis system further includes an electrochemical control device that applies an electrochemical reaction to at least one of solutions injected into the two cells, respectively, and the control terminal further controls the electrochemical control device so as to continuously perform the plurality of processing steps.

In the hydrogen analysis system, the plurality of processing steps include a first processing step of performing electrolytic polishing or chemical polishing the steel material to be measured, a second processing step of inactivating the surface of the steel material to be measured subjected to the electrolytic polishing or the chemical polishing, and a third processing step of replacing hydrogen, adsorbed on the inactivated surface of the steel material to be measured, with replacing-metal ions.

In the hydrogen analysis system, the third processing step further includes a processing of injecting an inert gas into the cell on the hydrogen detection side.

In the hydrogen analysis system, the solution supply/discharge control mechanism continuously performs supply/discharge control of each of solutions used in the plurality of processing steps on the basis of control from the control terminal.

### Effects of the Invention

According to the present invention, a test time for measuring hydrogen diffusion in a steel material can be shortened. Further, according to the present invention, the reproducibility of the position where hydrogen exists in the steel material can be improved.

### BRIEF DESCRIPTION OF DRAWINGS

FIG. 1 is a diagram illustrating a configuration of a hydrogen analysis system.

FIG. 2 is a diagram illustrating a processing flow of a hydrogen analysis method.

### DESCRIPTION OF EMBODIMENTS

### Summary of the Invention

A first feature of the present invention is that a solution supply/discharge control mechanism for injecting and discharging a solution into and from each of the two cells is added to the conventional hydrogen analysis system provided with two cells used in the Devanathan method, and a control terminal controls the solution supply/discharge control mechanism on the basis of a predefined procedure to continuously perform a plurality of processing steps that are performed for analyzing hydrogen diffused from the inside to the surface of the steel material.

Hence the solution exchange in the cell can be automatically performed, and the main processing using the metal ion replacement method and the pre-processing and the post-processing associated with the main processing can be continuously performed in the same experimental system while the test surface of the steel material is fixed. As a result, the processing process can be simplified, and the test time for measuring hydrogen diffusion in the steel material can be shortened.

A second feature of the present invention is that the processing of inactivating the surface of the steel material is performed before the main processing, or an inert gas is injected into the solution during the main processing.

Thereby, the contamination of the solution can be reduced, and a change in the pH of the replacing-metal ion solution at the time of replacement with replacing-metal ions can be prevented. This results in elimination of a situation where replacing-metal ions precipitate as a compound based on a change in pH, making it possible to improve the reproducibility of the position where hydrogen exists in the steel material.

Hereinafter, an embodiment for carrying out the present invention will be described with reference to the drawings.

Configuration of Hydrogen Analysis System

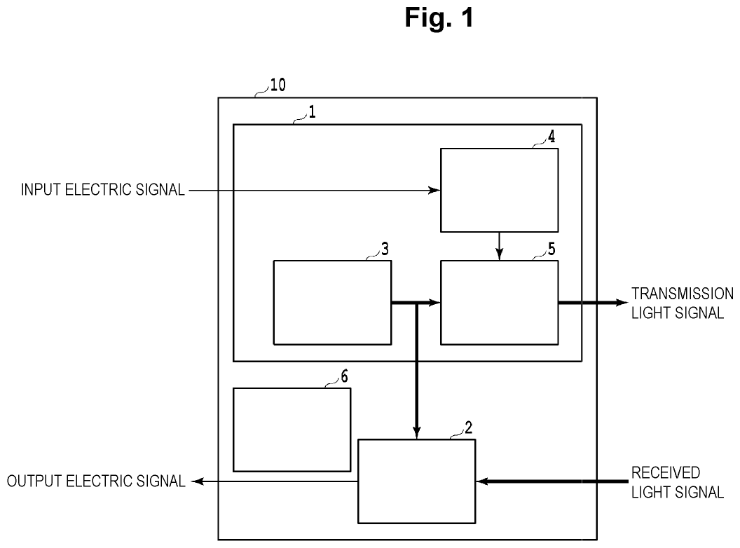

FIG. 1 is a diagram schematically illustrating an overall configuration of a hydrogen analysis system 1 according to the present embodiment. The hydrogen analysis system 1 is a system for analyzing hydrogen that is diffused from the inside to the surface of a steel material 100 and is provided with a hydrogen generation side and a hydrogen detection side having mutually the same configuration. Hereinafter, a metal sample 100 is used as an example of the steel material 100 to be measured.

On the hydrogen generation side illustrated on the left side of FIG. 1, the hydrogen analysis system 1 includes a first cell 11a, a first discharge control valve 12a, a first gasket 13a, a first solution supply pipe 14a, a first gas supply pipe 15a, and a first potentiostat/galvanostat 18a having a first counter electrode 16a and a first reference electrode 17a.

The first cell 11a has at its bottom a first solution discharge pipe 19a configured to discharge the solution injected into the cell out of the cell and has at its side a first solution release window 20a configured to bring the solution injected into the cell into contact with the metal sample 100.

The first discharge control valve 12a is an automatic regulating valve or a shut-off valve having a structure and function for controlling the opening and closing of the first solution discharge pipe 19a. The first discharge control valve 12a is electrically and physically connected to a solution supply/discharge control device 21 and opens or closes the first solution discharge pipe 19a on the basis of an opening control signal or a closing control signal from the solution supply/discharge control device 21.

The first gasket 13a is a fixing seal material having a ring shape surrounding the first solution release window 20a and configured to give airtightness and liquid-tightness to the structure of the first cell 11a with the metal sample 100 held by the first cell 11a and a second cell 11b.

The first solution supply pipe 14a is a pipeline provided in the upper portion of the first cell 11a and configured to inject a solution into the cell. The first solution supply pipe 14a is, for example, connected to a plurality of solution reservoirs in which a plurality of different types of solutions are stored via a solution selection valve and injects into the cell a solution selected on the basis of a solution selection control signal from the solution supply/discharge control device 21 to the solution selection valve.

Note that the first solution supply pipe 14a, the plurality of solution reservoirs, the solution selection valve, the first discharge control valve 12a, and the solution supply/discharge control device 21 constitute a solution supply/discharge control mechanism that injects and discharge a solution into and from the first cell 11a and controls the supply/discharge of the solution to be injected into and discharged from the first cell 11a.

The first gas supply pipe 15a is a pipeline inserted into the cell from the upper portion of the first cell 11a and configured to inject a gas into the cell. The first gas supply pipe 15a is connected to a gas chamber storing an inert gas via a gas supply valve and injects the inert gas into the cell on the basis of a gas supply control signal from a gas supply control device 22 to the gas supply valve.

Note that the first gas supply pipe 15a, the gas chamber, the gas supply valve, and the gas supply control device 22 constitute a gas supply control mechanism that injects a gas into the first cell 11a and controls the supply of the gas to be injected into the first cell 11a.

The first potentiostat/galvanostat 18a is an electrochemical control device that is connected to the first counter electrode 16a and the first reference electrode 17a inserted into the cell and gives an electrochemical reaction to the solution in the cell, with the metal sample 100 as a working electrode.

The configuration on the hydrogen generation side has been described thus far. The hydrogen detection side illustrated on the right side of FIG. 1 has the same configuration as that of the hydrogen generation side. That is, as illustrated on the right side of FIG. 1, on the hydrogen detection side, the hydrogen analysis system 1 includes the second cell 11b having a second solution discharge pipe 19b and a second solution release window 20b, a second discharge control valve 12b, a second gasket 13b, a second solution supply pipe 14b, a second gas supply pipe 15b, and a second potentiostat/galvanostat 18b having a second counter electrode 16b and a second reference electrode 17b.

In addition, as illustrated on the upper side of FIG. 1, the hydrogen analysis system 1 further includes the solution supply/discharge control device 21, the gas supply control device 22, and a control terminal 23.

The solution supply/discharge control device 21 has a function of transmitting a solution selection control signal to each of solution selection valves provided between the plurality of solution reservoirs and the first solution supply pipe 14a and between the plurality of solution reservoirs and the second solution supply pipe 14b, respectively, on the basis of a solution injection control signal from the control terminal 23, and injecting a predetermined solution into each of the first cell 11a and the second cell 11b.

The solution supply/discharge control device 21 has a function of transmitting an opening control signal or a closing control signal to the first discharge control valve 12a and the second discharge control valve 12b on the basis of a solution discharge control signal from the control terminal 23, and discharging the solution in the cell out of the cell.

The gas supply control device 22 has a function of transmitting a gas supply control signal to each of the gas supply valves provided between the gas chamber and the first gas supply pipe 15a and between the gas chamber and the second gas supply pipe 15b, respectively, on the basis of a gas injection control signal from the control terminal 23, and injecting an inert gas into each of the first cell 11a and the second cell 11b.

The control terminal 23 is a computer for controlling the first potentiostat/galvanostat 18a, the second potentiostat/galvanostat 18b, the solution supply/discharge control device 21, and the gas supply control device 22.

The control terminal 23 has a function of storing in a storage unit a plurality of test patterns in which procedures for measuring hydrogen diffused from the inside to the surface of the metal sample 100 are predefined. Further, the control terminal 23 has a function of automatically controlling all or some of the first potentiostat/galvanostat 18a, the second potentiostat/galvanostat 18b, the solution supply/discharge control device 21, and the gas supply control device 22 in accordance with a procedure of a test pattern selected by a user. It is thereby possible to continuously perform a plurality of processing steps that are performed for analyzing hydrogen diffused from the inside to the surface of the metal sample 100, that is, all of pre-processing, main processing, and post-processing included in the test pattern selected by the user.

Note that the control terminal 23 also has a function of, when sequentially performing a plurality of processing steps included in the test pattern selected by the user, displaying processing details scheduled to be executed on a screen at the timing of performing each processing step, and changing the processing predefined in the test pattern to processing desired by the user when the user desires another processing. It is difficult to register all test patterns in advance, and a certain number of test patterns are registered to enable fine adjustment of the processing details.

Preparation of Hydrogen Analysis System

In a case where the hydrogen diffusion measurement test of the metal sample 100 is performed using the hydrogen analysis system 1 described above, the user mechanically polishes the metal sample 100 and holds the mechanically polished metal sample 100 between the first solution release window 20a of the first cell 11a and the second solution release window 20b of the second cell 11b via the first gasket 13a and the second gasket 13b.

The first counter electrode 16a and the first reference electrode 17a of the first potentiostat/galvanostat 18a are disposed as necessary in the first cell 11a, the second counter electrode 16b and the second reference electrode 17b of the second potentiostat/galvanostat 18b are provided as necessary in the second cell 11b, and the metal sample 100 is used as the working electrode, to make the electrochemical control of the solution in the cell and the metal sample 100 executable through the control terminal 23.

Further, the injection/discharge processing of the solution or the inert gas into/from the first cell 11a and the second cell 11b is made executable through the control terminal 23 under the control of the solution supply/discharge control device 21 and the gas supply control device 22.

The upper portion of each of the first cell 11a and the second cell 11b is covered with a lid to seal the inside of each cell. The cell is preferably made of glass, but when the cell is desired to have impact resistance, a plastic having good chemical resistance may be used.

Note that the first solution supply pipe 14a and the second solution supply pipe 14b also have a function of controlling a flow rate of a solution in the vicinity of the metal sample 100 when brought close to the surface of the metal sample 100. Further, the first gas supply pipe 15a and the second gas supply pipe 15b also have a function of removing bubbles generated with an electrochemical reaction when brought close to the surface of the metal sample 100.

Measurement Test Method for Hydrogen Diffusion

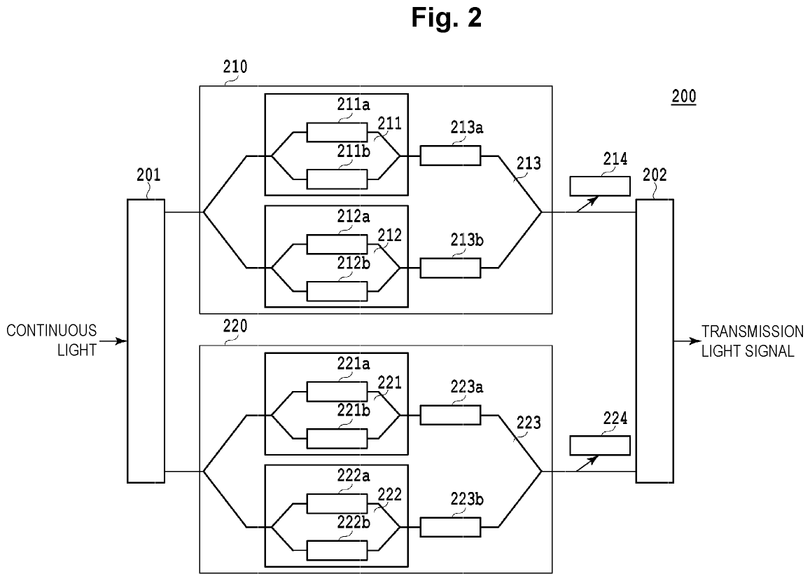

Next, a measurement test method for hydrogen diffusion in the metal sample 100 will be described. FIG. 2 is a diagram illustrating a processing flow of a measurement test for hydrogen diffusion in the metal sample 100. In this processing flow, the case of performing the pre-processing only on the second cell 11b will be described. The pre-processing may be performed on the first cell 11a.

Zeroth processing step (preparation; step S0);

The user mechanically polishes the surface of the metal sample 100 and holds the mechanically polished metal sample 100 between the first solution release window 20a of the first cell 11a and the second solution release window 20b of the second cell 11b. Thereafter, the user selects the desired test pattern from a plurality of test patterns displayed on the screen of the control terminal 23. Thereafter, the measurement test corresponding to the selected desired test pattern is started automatically.

Note that one test pattern is made up of a plurality of processing steps, and one or more of a plurality of different processing steps is predefined in one processing step. If processing details of each processing step are described for each test pattern, the amount of description would increase, and hence in the following, a plurality of processing that can be executed in the respective processing steps will be described together.

Further, if the control of the first potentiostat/galvanostat 18a, the second potentiostat/galvanostat 18b, the solution supply/discharge control device 21, and the gas supply control device 22 by the control terminal 23 is clearly described each time, it would be lengthy and rather hinder the understanding, so that the processing is to be performed on the basis of the control by the control terminal 23 corresponding to the desired test pattern.

First processing step (pre-processing; step S1a);

In the first processing step (step S1a), a hydrogen detection surface 100b of the metal sample 100 is cleansed.

Specifically, the solution supply/discharge control device 21 injects an organic solvent into the second cell 11b to perform degreasing treatment of the hydrogen detection surface 100b and performs drainage treatment after the degreasing treatment. Thereafter, the solution supply/discharge control device 21 injects pure water into the second cell 11b and discharges the pure ware, thereby performing water washing treatment of the hydrogen detection surface 100b. By repeating the injection and discharge of each solution of the organic solvent and pure water at any predetermined number of times, pre-washing can be performed. It is possible to optionally set whether the degreasing and washing treatment is performed on a hydrogen generation surface 100a of the metal sample 100 as well.

First processing step (pre-processing; step S1b);

The control terminal 23 determines whether the test pattern selected by the user includes the electrolytic polishing treatment or the chemical polishing treatment, and when the electrolytic polishing treatment or the chemical polishing treatment is included, the processing proceeds to step S1c, and when the electrolytic polishing treatment or the chemical polishing treatment is not included, the processing proceeds to the second processing step (pre-processing) of step S2a or the third processing step (main processing) of step S3a.

The choice of execution and the combination of execution or non-execution of the electrolytic polishing or the chemical polishing are predefined for the desired test pattern, but the user may optionally choose or change the execution timing of the first processing step. In the case of not performing the electrolytic polishing treatment or the chemical polishing treatment, the processing proceeds to the main processing after step S3a, but the surface of the metal sample 100 immediately after the mechanical polishing is in an activated state, and hence the processing proceeds to the main processing after step S3a after the lapse of about one day. On the other hand, when it is desired to perform the main processing immediately after the mechanical polishing, the processing proceeds to step S2a to actively perform inactivation treatment in order to reduce the activated state of the surface of the metal sample 100.

First processing step (pre-processing; steps S1c to S1e);

In the first processing step (steps S1c to S1e), the hydrogen detection surface 100b of the metal sample 100 is electrolytically polished or chemically polished.

Specifically, the solution supply/discharge control device injects an electrolytic polishing solution or a chemical polishing solution into the second cell 11b to perform the electrolytic polishing or the chemical polishing of the hydrogen detection surface 100b, and performs drainage treatment after the electrolytic polishing or the chemical polishing.

In the case of performing the electrolytic polishing, the solution supply/discharge control device 21 injects an adjusted solution, such as a 20% perchloric acid ethanol solution, into the second cell 11b, and the second potentiostat/galvanostat 18b applies a voltage to the second counter electrode 16b. Thereby, the electrolytic polishing treatment is performed, and the solution is discharged after completion of the treatment.

In the case of performing the chemical polishing, the solution supply/discharge control device 21 injects an adjusted solution, such as a 5% nitric acid ethanol solution, into the second cell 11b and discharges the solution after the elapse of an arbitrary time such as 10 seconds. Thereby, the chemical polishing is performed.

Each treatment condition of the electrolytic polishing or the chemical polishing is adjusted in advance. For example, the current density, voltage, and polishing time are adjusted in accordance with the surface area of the metal sample 100.

Thereafter, cleaning treatment is performed, and the processing proceeds to step S2a.

Second processing step (pre-processing; steps S2a to S2b);

In the second processing step (steps S2a to S2b), the hydrogen detection surface 100b of the metal sample 100 subjected to the degreasing and washing treatment (step S1a) or subjected to the electrolytic polishing treatment or the chemical polishing treatment (steps S1c to S1e) is inactivated (the active metal surface after the polishing is inactivated).

For example, there are a method of using passivation by immersion in an alkali solution and a method of performing anodic polarization by electrochemical control. In either case, an alkaline solution may be used as the solution. For example, a 0.1% aqueous solution of potassium hydroxide is used.

Although it is desirable to confirm the passivation in advance in the case of performing the immersion in an alkali solution, sufficient passivation can be expected in an immersion time of about 30 minutes for many metal materials. Therefore, the solution supply/discharge control device 21 injects an alkali solution into the second cell 11b and immerses the hydrogen detection surface 100b of the metal sample 100 in the alkali solution for 30 minutes.

In the case of performing the anodic polarization, the solution supply/discharge control device 21 injects an alkali solution into the second cell 11b, and the second potentiostat/galvanostat 18b applies a current voltage to the second counter electrode 16b or the second reference electrode 17b, with the metal sample 100 as the working electrode, to passivate the alkali solution. Since the electrochemical control is performed actively, the passivation can be completed more quickly than when the alkaline solution immersion is performed. The reaction rate may be increased and passivation may be promoted by heating with a heater or by infrared heating. By increasing the temperature of the solution or the like, the effect of releasing hydrogen having entered the metal sample 100 in the first processing step can also be expected.

Thereafter, cleaning treatment is performed, and the processing proceeds to step S3a.

Third processing step (main processing; steps S3a to S3d);

In the third processing step (steps S3a to S3d), the position where hydrogen exists is visualized by replacing hydrogen, adsorbed on the surface of the metal sample 100 subjected to the degreasing/washing treatment (step S1a) or the deactivating treatment (steps S2a to S2b) after the electrolytic polishing or the chemical polishing, with replacing-metal ions.

Specifically, hydrogen is electrochemically generated in the first cell 11a, and the metal ion replacement is performed in the second cell 11b.

As a method of generating hydrogen in the first cell 11a, for example, there is a method of using a corrosion reaction by a corrosive solution. Further, there is a method in which hydrogen generation accompanying atmospheric corrosion is simulated by releasing the solution to the atmosphere without injecting the solution, and acceleration is performed by a temperature/humidity cycle in a constant temperature/humidity tank or the like. In addition, there is a method in which a current and a voltage are applied using the counter electrode and the reference electrode to perform a cathode charge by electrochemical control, regardless of the liquid property of the solution.

Hence the user may select hydrogen generation by a corrosion reaction or hydrogen generation by a cathode charge. As the corrosive solution, an aqueous solution of ammonium thiocyanate, salt water, hydrochloric acid, or the like is used. In the case of performing the cathode charge, it is preferable to use a solution such as an aqueous solution of sodium hydrogen carbonate, which hardly causes a change in the liquid property, for example, −1000 mV vs SSE for voltage control and 50 mA/mm² for current density control. Therefore, the solution supply/discharge control device 21 injects any solution into the first cell 11a to generate hydrogen, and the first potentiostat/galvanostat 18a applies a current/voltage to the first counter electrode 16a or the first reference electrode 17a, with the metal sample 100 as the working electrode as required, to generate hydrogen.

As a method of the metal ion replacement performed in the second cell 11b, for example, the silver decoration method of Non-Patent Literature 2 is used. As described above, the silver decoration method is a method in which metal which contains diffusible hydrogen is immersed in a replacing-metal ion solution to replace hydrogen diffused from the inside to the surface of the metal with replacing-metal ions in the replacing-metal ion solution. For example, it is possible to apply a method of immersing a hydrogen-containing metal sample in a general aqueous solution of 4.3 mM potassium silver cyanide. Thus, the solution supply/discharge control device 21 injects a replacing-metal ion solution, such as an aqueous solution of potassium silver cyanide, into the second cell 11b.

In the silver decoration method, it is desirable to conduct the test with the pH of the replacing-metal ion solution being 7 or more. This is because hydrogen cyanide is generated in an acidic solution and is dangerous, and silver cyanide may be deposited with the generation of hydrogen cyanide and be mixed with silver having replaced hydrogen. One of the reasons why the pH of the replacing-metal ion solution decreases due to the deposition of silver cyanide is dissolution of carbon dioxide. Therefore, the gas supply control device 22 injects an inert gas into the second cell 11b. It is thereby possible to prevent the pH of the replacing-metal ion solution from decreasing.

The hydrogen generated in the first cell 11a enters the metal sample 100 through the hydrogen generation surface 100a which is one surface (rear surface) of the metal sample 100 to be contained inside the metal sample 100, and is diffused from the hydrogen detection surface 100b which is the other surface (front surface). Hydrogen diffused from the hydrogen detection surface 100b is then replaced with replacing-metal ions in the replacing-metal ion solution. The replacing-metal ions are deposited as replacing-metal particles at the position where hydrogen exists and remain even after the replacing-metal ion solution is removed, and hence it is possible to confirm the position where hydrogen diffused from the inside to the surface of the metal sample 100 exists by observing the deposition position of the replacing-metal particles after cleaning of the metal sample 100 in the next fourth processing step.

Fourth processing step (post-processing; step S4);

In the fourth processing step (step S4), post-processing such as neutralization is performed.

Specifically, the solution supply/discharge control device 21 injects a neutralizing solution into each of the first cell 11a and the second cell 11b to neutralize the metal sample 100 and performs waste liquid treatment after the neutralization treatment. Thereafter, the solution supply/discharge control device 21 injects pure water into each of the first cell 11a and the second cell 11b and discharges the pure water, thereby performing the washing treatment of the metal sample 100. The gas supply control device 22 stops the injection of the inert gas. Thereafter, the user removes the metal sample 100 from between the first cell 11a and the second cell 11b.

As for the test time of the third processing step, a hydrogen permeation test by the Devanathan method is performed in advance, and the time, from the generation of hydrogen until the hydrogen is diffused and arrives at the hydrogen detection surface 100b of the metal sample 100, is set as the shortest time. Thereafter, as the test time is extended, the deposited silver particles increase, so that the test may be finished at an arbitrary time depending on the resolution of an observation method.

As described above, according to the present embodiment, the solution supply/discharge control device 21 is added to the conventional hydrogen analysis system having two cells used in the Devanathan method, and the control terminal 23 controls the solution supply/discharge control device 21 on the basis of a predefined procedure. Here, the solution supply/discharge control device 21 is a device for injecting and discharging a solution into each of the first cell 11a and the second cell 11b respectively corresponding to the two cells. Thus, the first processing step to the fourth processing step to analyze hydrogen diffused from the inside to the surface of the metal sample 100 are performed continuously. This enables automatic solution exchange in the cell. Moreover, the main processing using the metal ion replacement method and the pre-processing and post-processing associated with the main processing can be continuously performed in the same experimental system while the test surfaces 100a and 100b of the metal sample 100 are fixed. As a result, the processing process can be simplified, and the test time for measuring hydrogen diffusion in the metal sample 100 can be shortened.

According to the present embodiment, the processing of inactivating the surface of the metal sample 100 is performed or an inert gas is injected into the solution, so that it is possible to reduce the contamination of the solution and prevent a change in the pH of the replacing-metal ion solution at the time of replacement with replacing-metal ions. This results in elimination of a situation where replacing-metal ions precipitate as a compound based on a change in pH, making it possible to improve the reproducibility of the position where hydrogen exists in the steel material.

### REFERENCE SIGNS LIST

1 Hydrogen analysis system
11a First cell
12a First discharge control valve
13a First gasket
14a First solution supply pipe
15a First gas supply pipe
16a First counter electrode
17a First reference electrode
18a First potentiostat/galvanostat
19a First solution discharge pipe
20a First solution release window
11b Second cell
12b Second discharge control valve
13b Second gasket
14b Second solution supply pipe
15b Second gas supply pipe
16b Second counter electrode
17b Second reference electrode
18b Second potentiostat/galvanostat
19b Second solution discharge pipe
20b Second solution release window
21 Solution supply/discharge control device
22 Gas supply control device
23 Control terminal

1. A hydrogen analysis system comprising:
two cells that hold a steel material to be measured with side solution release windows;
a solution supply/discharge control mechanism that injects and discharges a solution into and from each of the two cells, and controls supply/discharge of the solution to be injected into and discharged from each of the two cells;
a gas supply control mechanism that injects a gas into a cell on a hydrogen detection side of the two cells and controls supply of the gas to be injected into the cell on the hydrogen detection side; and
a control terminal that controls the solution supply/discharge control mechanism and the gas supply control mechanism,
wherein the control terminal controls the solution supply/discharge control mechanism and the gas supply control mechanism on the basis of a predefined procedure to continuously perform a plurality of processing steps that are performed for analyzing hydrogen diffused from an inside to a surface of the steel material to be measured.

2. The hydrogen analysis system according to claim 1, further comprising
an electrochemical control device that applies an electrochemical reaction to at least one of solutions injected into the two cells, respectively,
wherein the control terminal further controls the electrochemical control device so as to continuously perform the plurality of processing steps.

3. The hydrogen analysis system according to claim 1, wherein the plurality of processing steps include:
a first processing step of performing electrolytic polishing or chemical polishing the steel material to be measured;
a second processing step of inactivating the surface of the steel material to be measured subjected to the electrolytic polishing or the chemical polishing; and
a third processing step of replacing hydrogen, adsorbed on the inactivated surface of the steel material to be measured, with replacing-metal ions.

4. The hydrogen analysis system according to claim 3, wherein the third processing step further includes a processing of injecting an inert gas into the cell on the hydrogen detection side.

5. The hydrogen analysis system according to claim 1, wherein the solution supply/discharge control mechanism continuously performs supply/discharge control of each of solutions used in the plurality of processing steps on the basis of control from the control terminal.

6. The hydrogen analysis system according to claim 2, wherein the plurality of processing steps include:
a first processing step of performing electrolytic polishing or chemical polishing the steel material to be measured;
a second processing step of inactivating the surface of the steel material to be measured subjected to the electrolytic polishing or the chemical polishing; and
a third processing step of replacing hydrogen, adsorbed on the inactivated surface of the steel material to be measured, with replacing-metal ions.

7. The hydrogen analysis system according to claim 2, wherein the solution supply/discharge control mechanism continuously performs supply/discharge control of each of solutions used in the plurality of processing steps on the basis of control from the control terminal.

8. The hydrogen analysis system according to claim 3, wherein the solution supply/discharge control mechanism continuously performs supply/discharge control of each of solutions used in the plurality of processing steps on the basis of control from the control terminal.

9. The hydrogen analysis system according to claim 4, wherein the solution supply/discharge control mechanism continuously performs supply/discharge control of each of solutions used in the plurality of processing steps on the basis of control from the control terminal.
